(19) United States
(12) Patent Application Publication
(10) Pub. No.: US 2007/0080211 A1
(43) Pub. Date: Apr. 12, 2007

(54) Credit card payment validation system

(76) Inventor: Han-ping Chen, Saratoga, CA (US)

Correspondence Address: Han-ping Chen, P.O. Box 2871, Saratoga, CA, 95070, US

(21) Appl. No.: 11/246,158

(22) Filed: Oct. 11, 2005

(51) Int. Cl. G06K 5/00

(52) U.S. Cl. 235/380

(57) ABSTRACT

A credit card payment method and system ensures the security and robustness of payment transaction processing and validation procedure by utilizing an ordered list of supplementary credit card numbers and by requiring a card holder to present said supplementary credit card numbers, one by one, according to a pre-determined selection rules for consecutive payment transactions. Said credit card payment method and system further allows a supplementary credit card number to carry information regarding the transaction payment amount to enhance the security of payment processing. Also, said method and system is cost-effective to implement and highly compatible with the current credit card payment verification procedure.

### BACKGROUND OF THE INVENTION

This invention relates to bank card, credit card, debit card, cash card, and other account verification devices.

Consumers often use credit cards and debit cards to purchase merchandises at point-of-sale locations, via public telephones, or over the Internet.

During a purchasing process, certain personal data are released, although in a limited way. Especially for payment transactions through telephones or over the Internet, the security of personal information is at risk.

Even when not conducting transactions, personal data may also fall into wrong hands due to improper placement or disposition of documents. These factors may lead to unauthorized uses of bank cards. This situation is sometimes referred to as identity theft.

To enhance the security of bank cards, issuing institutions assign card verification codes (CVC) and personal identification numbers (PIN) to bank card accounts. To implement the security, a merchant needs to ask the purchaser to present either a CVC or a PIN to verify the validity.

In a way, this still constitutes a release of personal bank card information. It is only secure if all the parties involved in the transaction are trustable.

Furthermore, there are still circumstances that merchants only use a credit card number to conduct payment transactions. They do not use a CVC or a PIN code.

Some merchants that use a non-code payment method may be considered highly trustable by the issuing institution. They may also have special agreements with the issuing institution.

Some merchants may take the risk themselves, in order to simplify the verification procedure. Examples include parking lots and self-service gas stations. These non-code users constitute a potential loophole in the verification process.

For e-commerce transactions over the Internet, certain purchasers, because of unfamiliarity with the procedure or due to lack of patience, may issue an incorrect forward or backward command that causes a payment transaction to be processed more than once. This constitutes another potential problem for payment transaction processing.

### BRIEF SUMMARY OF THE INVENTION

This invention proposes a method and system to enhance the security and robustness of bank card transactions.

This invention provides a method and system to prevent unauthorized usage of bank cards due to release of personal information during payment transaction processing or misplacement of documents.

This invention provides a method and system for a purchaser to deliver a credit card number to a seller without compromising the security of subsequent usage.

This invention proposes a method which is cost-effective and highly compatible with the current verification procedure.

This invention further proposes a method which offers flexibility and tolerance for certain special handling procedures used by some merchants when processing credit card transactions.

This invention further provides a method to prevent a transaction from being unintentionally processed more than once.

### BRIEF DESCRIPTION OF THE DRAWINGS

FIG. 1 is a diagram of a prior art bank card verification process.

FIG. 2 shows a prior art bank card data structure.

FIG. 3 shows a preferred embodiment of the present invention for a bank card data structure.

FIG. 4 shows a preferred embodiment of the present invention for a bank card verification process.

FIG. 5 shows a number of preferred embodiments of the present invention for a supplementary card number chart.

FIG. 6 shows a number of preferred embodiments of the present invention for a card holder to carry a list of supplementary card numbers.

FIG. 7 shows a preferred embodiment of the present invention for a card number storage device.

FIG. 8 shows a preferred embodiment of the present invention for a card number maintenance device.

### DETAILED DESCRIPTION OF THE INVENTION

The present invention will be illustrated with some preferred embodiments.

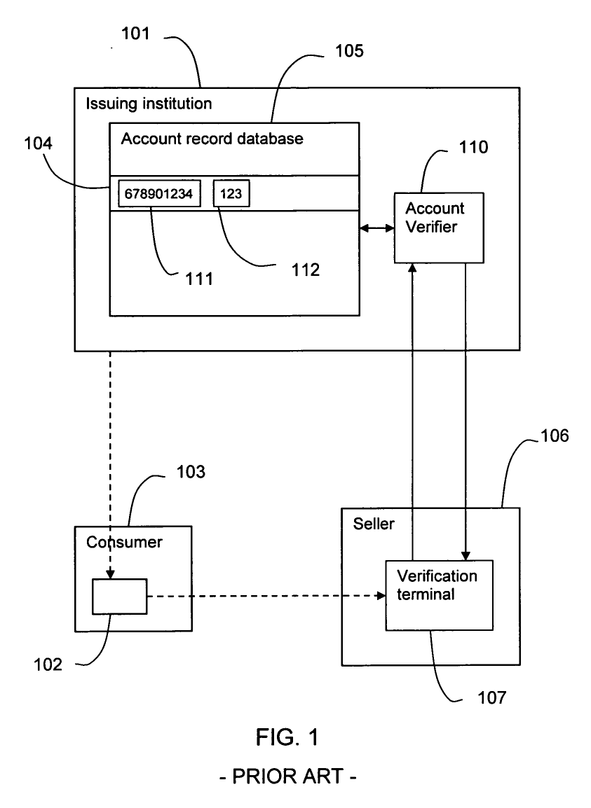

FIG. 1 shows a prior art bank card verification process. Initially, an issuing institution 101 issues a bank card 102 to a consumer 103. The bank card 102 contains a set of bank card data, such as a card number, a consumer name, an expiry date, and a card verification code. The issuing institution 101 keeps a consumer account record 104 in the account record database 105. A consumer account record 104 contains an account number 111 and a card verification code 112. It may also contain other account data such as an expiry date, a maximum limit amount, the current balance, the current status, the consumer name, the consumer address, previous transactions, and other reference data.

To make a purchase, the consumer 103 provides the seller 106 with the bank card data. The seller 106 transfers the bank card data through a verification terminal 107 to an account verifier 110 at the issuing institution 101 for verification. The seller 106 may also transfer the seller identification and the purchase amount together with the bank card data.

The account verifier 110 at the issuing institution 101 verifies the validity of received bank card data by searching the account record database 105 for a matched consumer account record 104 which matches the received bank card number. If a matched record is found, the account verifier 110 verifies other account data for consistency and limitations. The issuing institution 101 then sends the verification results to the seller 106.

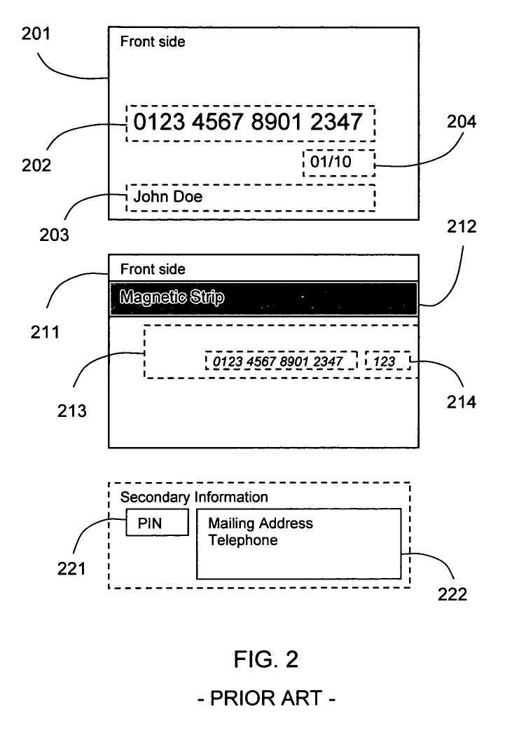

FIG. 2 shows a prior art bank card data structure. The front side 201 of the bank card contains a card number 202, a consumer name 203, and an expiry data 204.

The back side 211 of bank card contains a magnetic stripe 212 and a signature area 213. It also contains a card verification code (CVC) 214. Items 202, 203, 204, and 214 may be classified as the primary bank card data.

Associating with a bank card, a consumer also maintains secondary information which includes a personal identification number (PIN) 221 and other personal data 222 such as a mailing address and a telephone number. Items 221 and 222 may be classified as the secondary bank card data.

Besides verifying the primary bank card data, some sellers also verify the secondary bank card data.

For a consumer bank card, the card verification code (CVC) 214 is normally a 3-digit or 4-digit fixed numeric code. The personal identification number (PIN) 221 is also a fixed number, normally with 4 to 6 digits.

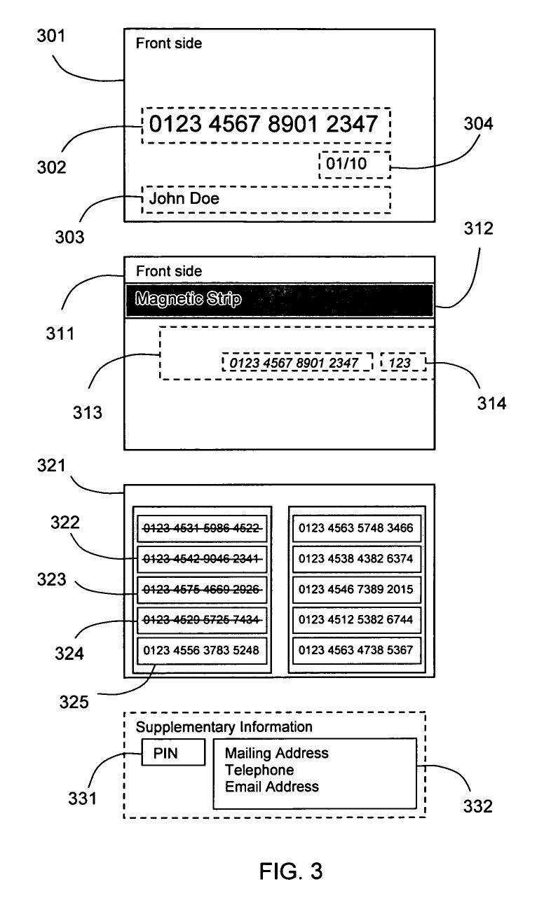

FIG. 3 shows a preferred embodiment of a bank card data structure. The front side 301 of the bank card contains a primary card number 302, a consumer name 303, and an expiry data 304. The back side 311 of the bank card contains a magnetic stripe 312 and a signature area 313. It also contains a primary card verification code (CVC) 314.

In addition, there is a companion supplementary card number chart 321 supplied by the issuing institution.

The supplementary card number chart 321 may be viewed as a list of supplementary card numbers such as 322, 323, 324, and 325. For each purchase transaction, the consumer selects a card number from the chart 321 to use as a transaction credit card number.

In other words, for payment transactions that require special security, instead of using a primary credit card number, a consumer uses a different supplementary credit card number for each individual purchase transaction.

Associating with a bank card, a consumer also maintains secondary information which includes a personal identification number (PIN) 331 and other personal data 332 such as a mailing address, a telephone number, and an email address.

A card number in the supplementary card number chart 321 contains three parts. The first 6 digits constitute a business identification code. The next 9 digits constitute a transaction-specific code. The last digit is a checking digit.

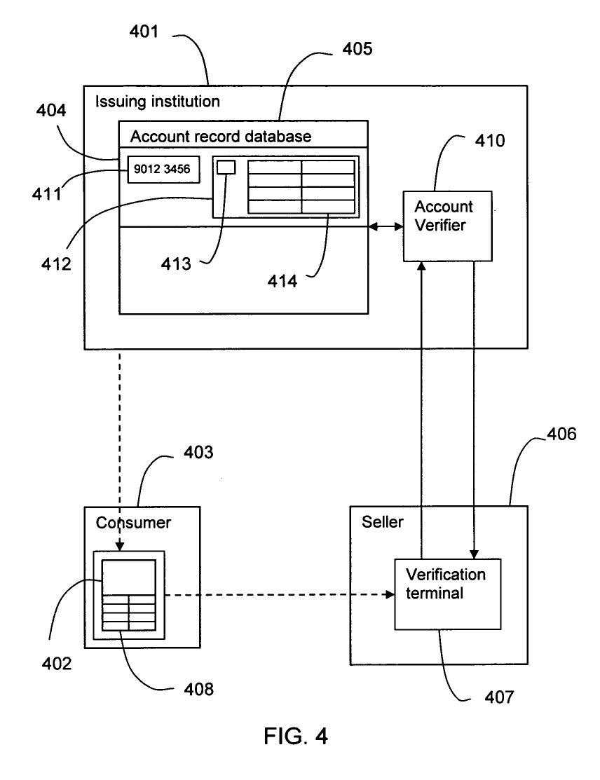

FIG. 4 shows a preferred embodiment of the present invention for a bank card verification process.

An issuing institution 401 issues a bank card 402 and a supplementary card number chart 408 to a consumer 403. The data structure of the bank card 402 and the supplementary card number chart 408 is as illustrated in FIG. 3.

The issuing institution 401 keeps a primary consumer account record 404 in the account record database 405. A primary consumer account record 404 contains an account number 411 and a supplementary card number descriptor 412. It may also contain other account data such as an expiry date, a maximum limit amount, the current balance, the current status, the consumer name, the consumer address, previous transactions, and other reference data.

The supplementary card number descriptor 412 contains a supplementary card number table 414 and a table index 413. The supplementary card number table 414 contains a list of supplementary card number entries. The table index 413 points to an expected supplementary card number entry in the supplementary card number table 414.

To make a purchase, the consumer 403 selects the current supplementary card number from the supplementary card number chart 408, as illustrated in FIG. 3. The consumer 403 provides the seller 406 with the current supplementary card number as the credit card number in the bank card data.

The seller 406 transfers the current supplementary card number through a verification terminal 407 to an account verifier 410 at the issuing institution 401 for verification. The seller 406 may also transfer the seller identification and the purchase amount together with the bank card data.

The account verifier 410 at the issuing institution 401 verifies the validity of received bank card data by trying to link the received bank card number to a target primary consumer account record 404 in the account record database 405.

The linking procedure may be performed in a number of ways. The account verifier 410 may search through the account record database 405 to find a primary consumer account record 404 in which the expected supplementary card number matches the received bank card number.

Alternatively, a verification system may maintain a current list of expected supplementary card numbers. The account verifier 410 searches through the current list to find an expected supplementary card number.

Normally, a consumer 403 also provides the seller 406 with a consumer name, illustrated in FIG as 303. The account verifier 410 may use the consumer name to identify a primary consumer account record 404.

If a target primary account record is found, the account verifier 410 verifies the received bank card number with the expected bank card number, indexed by the card number index 413, in the card number table 414.

A verification system may allow two or more customers to use the same name, as long as the expected credit card numbers are different.

The account verifier 410 may also verify other account data for consistency and limitations. The issuing institution 401 then sends the verification results to the seller 406.

If the transaction is successfully validated, the account verifier 410 modifies the card number index 413 to point to the next expected card number in the card number table 414.

The card number table 414 contains a limited number of card number entries. To operate the verification process on a continuous basis, a strategy is needed to either cycle through the card number entries, or to update the card number table contents as needed.

For illustration purpose, the account verifier 410 may use a cycle-through policy. If the current card number table index is the last card number entry in the key table, after a successful transaction validation, the account verifier 410 resets the card number table index to point to the first card number entry.

To use a table-updating policy, the account verifier 410 also needs to update the contents of the table with the next group of card number entries.

On the card holder side, after each successful payment transaction validation, the card holder marks off the current card number value that has just been used on the card number chart. The next card number value now appears to be a current card number value on the chart.

Most merchants, when receives the credit card information from a card holder, sends the credit card information to a verification institution for verification immediately.

However, some merchants may defer the verification process of a payment transaction until a later time. Examples include hotels that defer credit card processing until check-out time, and rental car companies that defer credit card processing until car return time.

To strictly ensure the security, a verification system may choose not to allow deferred processing.

To allow more flexibility, a verification system may allow a number of card numbers, associated with deferred payment transactions, to be skipped. It will accept the next following card number as a valid card number.

We may use the card number chart 321 in FIG.3 as an example to illustrate the verification procedure. The card number chart 321 contains a list of card numbers.

A card holder uses card number 322 in a first payment transaction. The card number 322 is sent by a first merchant to the verification system to be processed immediately.

Afterwards, the card holder uses card number 323 in a second payment transaction. A second merchant defers the verification process. It does not send card number 323 to the verification system to be processed immediately.

The card holder subsequently uses card number 324 in a third payment transaction. This time, a third merchant sends card number 324 to a verification system to be processed immediately.

At this point, the verification system normally expects to receive card number 323. To provide additional flexibility, the verification system also considers card number 324 to be an acceptable card number, assuming that card number 323 has been deferred by a merchant.

At a later time, the second merchant sends the deferred card number 323 for verification. At this time, the verification system normally expects to receive card number 325. It will also consider the deferred card number 323 to be an acceptable card number, as long as the deferred length of time is within a pre-defined reasonable time limit.

A credit card account may not contain a primary credit card number, only a list of supplementary credit card numbers.

For a credit card system with primary credit card numbers, the verification system may also allow a card holder, under certain environments, to use the primary card number to conduct payment transactions. This verification mode is essentially the same as a prior art credit card verification method.

In other words, a verification system with primary card numbers may allow two verification modes: a primary card number verification mode and a supplementary card number verification mode.

Usually, a merchant also requires the card holder to present a card verification code. The primary card verification code 314 may be used as the card verification code for all the supplementary card numbers.

In a different embodiment, each supplementary card number may be assigned a different card verification code to provide additional security.

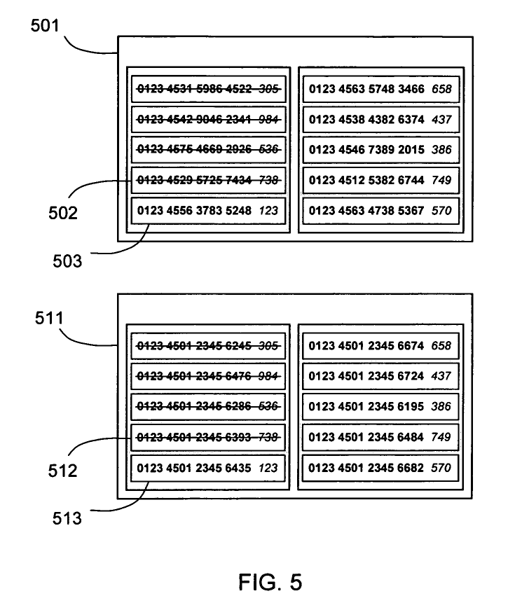

FIG. 5 shows a number of preferred embodiments of the present invention for a supplementary card number chart.

Supplementary card number chart 501 contains a list of supplementary card numbers, such as 502 and 503. Each supplementary card number is assigned a 3-digit card verification code.

To further enhance the security of payment transaction, a verification system may use a verification key to carry information about the payment transaction. Payment transaction information may include payment amount, payment date, or merchant identification. In this case, the verification system needs to receive the payment transaction information from the requester, along with the verification key to perform the validation.

Since a verification key may be just a 3-digit number, it may not contain an actual payment amount. The verification key may only contain a combined signature of the verification code and the current payment amount.

Supplementary card number chart 511 contains another list of supplementary card numbers, such as 512 and 513.

A card number in 511 contains four parts. The first 6 digits constitute a business identification code. The next 7 digits constitute a customer-specific account number. The next 2 digits constitute an intra-account transaction-specific code. The last digit is a checking digit.

Using this type of assignment for card numbers, all the card number with the same leading 13 digits are assigned to the same card holder account. The 2-digit intra-account transaction-specific code identifies the individual transaction. This transaction-specific code may also be used to carry transaction information such as a signature for payment amount. The check digit also needs to be adjusted accordingly.

The transaction-specific code, the checking digit, and the card verification code may be combined into a six-digit extended verification code. This extended verification code may also carry transaction information such as a signature for payment amount.

In order to retain the functionality and compatibility, the check digit needs to be preserved. Only five digits in the six-digit extended verification code are effectively usable.

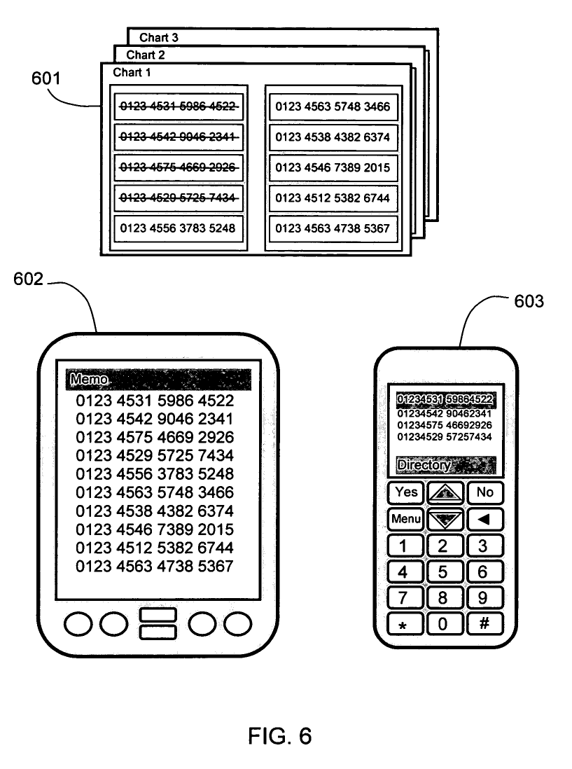

FIG. 6 shows a number of preferred embodiments of the present invention for a card holder to carry a list of supplementary card numbers.

Card number label set 601 contains a set of supplementary card number charts. The supplementary card numbers are printed on detachable labels. After each successful purchase validation, the corresponding supplementary card number label is physically detached from the card number chart.

A card holder may use a personal digital assistant (PDA) device 602 to carry the list of supplementary card numbers. The list of card numbers are loaded into the PDA, either as directory entries, memo contents, or other data entries.

A card holder may enter the card numbers on the PDA, or load the card numbers through a communication channel.

After each successful purchase validation, the corresponding card number item may be deleted from the list.

A card holder may also use a cellular telephone device 603 to carry the list of supplementary card numbers. The supplementary card numbers are loaded into the cellular telephone as directory entries. For a more complex cellular telephone, the supplementary card numbers may also be loaded as memo contents or other data entries.

A card holder may enter the supplementary card numbers on the cellular telephone, or load the supplementary card numbers through a communication channel.

After each successful purchase validation, the corresponding supplementary card number item may be deleted from the list.

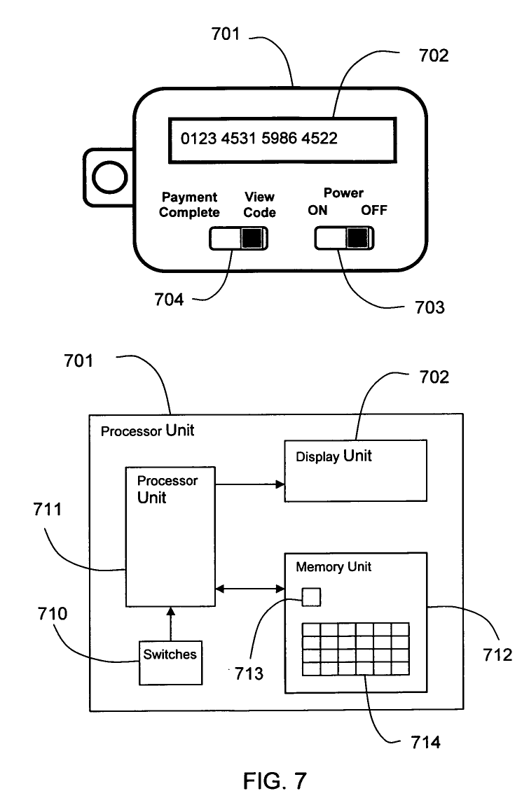

FIG. 7 shows a preferred embodiment of the present invention for a card number storage device. The upper portion of FIG. 7 shows the external appearance. The lower portion of FIG. 7 shows a structure block diagram.

From the external appearance, the card number storage device 701 appears as a key chain attachment.

From the internal structure, the card number storage device 701 contains a display unit 702 and a number of switches 710. The card number storage device 701 keeps a list of card number values in a memory unit 712.

The memory unit 712 contains a card number table 714 and a card number index 713. The card number table 714 contains a list of card number entries. The card number index 713 points to a current card number entry in the card number table 714.

A processor unit 711 controls the operation of the display unit 702, the switches 710, and the memory unit 712.

The Power switch 703 is a two-position switch which controls the power ON and OFF conditions. When the device power is turn on, the display unit 702 displays the current card number entry, indexed by the card number index 713. The card holder may give the current card number entry value to the seller as a card number for a payment transaction.

The Payment Complete switch 704 is also a two-position switch, normally set to the View Code position. After each successful purchase validation, the card holder toggles the Payment Complete switch 704 to the Payment Complete position. Upon this action, the processor unit 711 updates card number index 713 to point to the next card number entry in the card number table 714, as a new current card number entry.

Once the current card number value is updated, the card holder needs to toggle the Payment Complete switch 704 back to the View Code position to resume normal operation.

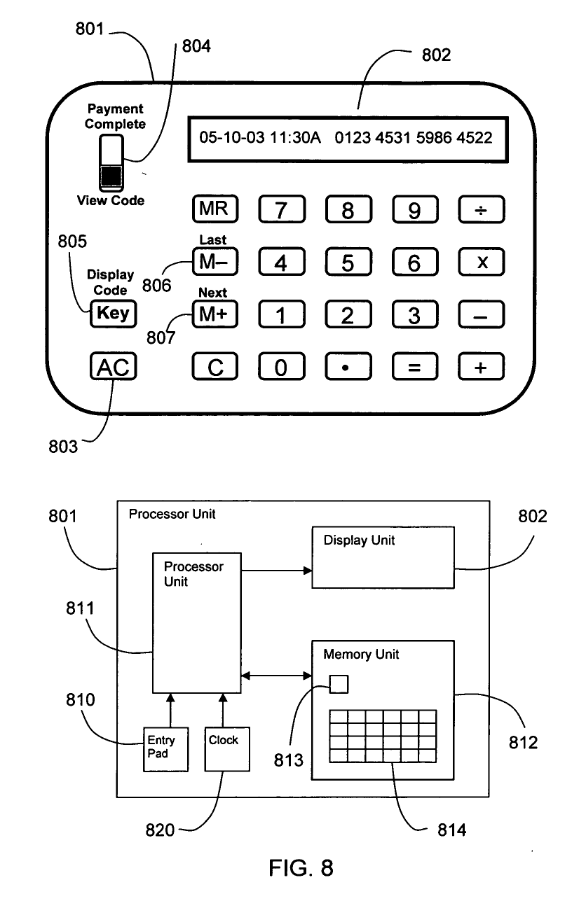

FIG. 8 shows a preferred embodiment of the present invention for a card number maintenance device. The upper portion of FIG. 8 shows the external appearance. The lower portion of FIG. 8 shows a structure block diagram.

The card number maintenance device 801 contains a display element 802 and an entry pad 810. The card number maintenance device 801 keeps a list of card number values in a memory unit 812.

The memory unit 812 contains a card number table 814 and a card number index 813. The card number table 814 contains a list of card number entries. The card number index 813 points to a current card number entry in the card number table 814.

A processor unit 811 controls the operation of the display unit 802, the entry pad 810, and the memory unit 812.

The Power button 803 controls the power ON and OFF conditions. When the device power is turn on, the display unit 802 displays the current card number entry, indexed by the card number index 813.

The operation of the Payment Complete switch 804 is similar to the operation of Payment Complete switch 704 described in FIG. 7.

To provide more flexibility, the card number maintenance device 801 includes more buttons. A Display Code button 805 instructs the device to display the current card number entry value on the display unit 802. A Last button 806 instructs the device to display the last card number entry value. A Next button 807 instructs the device to display the next card number entry value.

In addition, the card number maintenance device 801 includes a real-time clock unit 820. The real-time clock is used to keep a transaction history. At each payment completion, the processor unit 811 stores the transaction time in the memory unit 812.

Upon a Last button command, the display unit 802 displays the last transaction time along with the card number entry value. The Last button 806 and the Next button 807 are used to scroll backward and forward through previous transactions. The Display Code button 805 resets the display back to the current card number entry value.

Besides keeping track of the transaction history, this feature may assist the card holder to recover from a situation that the Payment Complete switch 804 was un-intentionally touched, which led to an incorrect updating of the current card number value.

With a card number verification system that allows deferred transaction processing, un-intentionally-skipped card number may also be simply considered as a card number that has been deferred, but never actually posted at a later time.

By adding a group of number buttons, the card number maintenance device 801 may include a security protection feature. The card number maintenance device 801 may require the purchaser to enter a password code in order to access the card numbers.

In addition, a consumer may enter a payment amount using the entry pad. For verification system with a card verification code, an intra-account transaction-specific code, or an extended verification code, as described in FIG.5, the processor unit 811 may use these special codes and the payment amount input to generate a final card number, and a final verification code, according to a pre-determined algorithm.

The final card number and verification code contains a combined signature of the special codes and the current payment amount.

The card number maintenance device 801 shown in FIG. 8 may also include calculator functions, which complements the transaction processing operation.

The present invention may be used in combination with either a card verification code (CVC) or a personal identification number (PIN). The CVC is also referred to, by different financial institutions, as a CVC2, CVV, CVV2, CVN, or CID. The term “verification code” or “verification key” are used to represent either a PIN or a version of the CVC numbers.

A bank card, depending on the payment terms, is referred to a credit card, a debit card, a check card, a cash card, an ATM card, or a similar name.

The verification of a payment transaction is also referred to as validation, authorization, approval, or a similar term.

The present invention is cost-effective to implement and highly compatible with the current account verification procedure.

I claim:

1. A credit card set comprising:
(a) a credit card identification means, containing a first account name;
(b) a card base number selection means, containing a first ordered list of three or more card base number entries, at least three of which are different in value;
wherein a card verification institution requires that a payment requester, when conducting a first payment transaction verification using a first type of purchasing procedure, to present:
(i) said first account name;
(ii) a first transaction-specific card number, derived, at least in part, from a first card base number entry, selected from said first ordered list, according to a first plurality of pre-determined card base number selection rules for consecutive occurrences of said first type of purchasing procedure;
wherein said card verification institution requires that said payment requester, when conducting a second payment transaction verification using said first type of purchasing procedure, to present:
(i) said first account name;
(ii) a second transaction-specific card number, derived, at least in part, from a second card base number entry, selected from said first ordered list, according to said first plurality of pre-determined card base number selection rules, said second card base number entry is different from said first card base number entry in value;
wherein said card verification institution requires that said payment requester, when conducting a third payment transaction verification using said first type of purchasing procedure, to present:
(i) said first account name;
(ii) a third transaction-specific card number, derived, at least in part, from a third card base number entry, selected from said first ordered list, according to said first plurality of pre-determined card base number selection rules, said third card base number entry is different from said first card base number entry and said second card base number entry in value.

2. The credit card set of claim 1, wherein said first plurality of pre-determined card base number selection rules specify that said payment requester selects said first card base number entry, said second card base number entry, and said third card base number entry, one by one, from said first ordered list, according to the order of the list.

3. The credit card set of claim 1, wherein said first plurality of pre-determined card base number selection rules specify that said payment requester, instead of selecting a first next card base number entry in said first ordered list, may skip forward within a first pre-determined number of card base number entries to select a first alternative card base number entry.

4. The credit card set of claim 1, wherein said first plurality of pre-determined card base number selection rules specify that said payment requester, instead of selecting a first next card base number entry in said first ordered list, may seek backward within a second pre-determined number of card base number entries to select a second alternative card base number entry, which is not previously used within a pre-determined time limit.

5. The credit card set of claim 1, wherein said first ordered list is printed on paper, stored in an electronic device, or generated in an electronic device.

6. The credit card set of claim 1, further comprises a primary credit card number,
wherein said card verification institution requires that said payment requester, when conducting a fourth payment transaction, using a second type of purchasing procedure, to present:
(i) said first account name;
(ii) said primary credit card number, said payment requester is not required to present a transaction-specific card number, derived, at least in part, from a card base number entry, selected from said first ordered list.

7. The credit card set of claim 1, further comprises a primary verification code,
wherein, when conducting a fourth payment transaction, using said first type of purchasing procedure, in which said payment requester presents:
(i) said first account name;
(ii) a fourth transaction-specific card number;
(iii) a transaction card verification code,
said card verification institution performs validation to determine:
(i) whether or not said fourth transaction-specific card number matches an expected card number, derived, at least in part, from a fourth card base number entry, selected from said first ordered list, according to said first plurality of pre-determined card base number selection rules;
(ii) whether or not said transaction card verification code matches an expected card verification code, derived, at least in part, from said primary verification code.

8. The credit card set of claim 1, further comprises a first plurality of verification base codes,
wherein each card base number entry in said first ordered list is assigned an associated verification base code from said first plurality of verification base codes;
wherein, when conducting a fourth payment transaction, using said first type of purchasing procedure, in which said payment requester presents:
(i) said first account name;
(ii) a fourth transaction-specific card number;
(iii) a transaction card verification code,
said card verification institution performs validation to determine:
(i) whether or not said fourth transaction-specific card number matches an expected card number, derived, at least in part, from a fourth card base number entry, selected from said first ordered list, according to said first plurality of pre-determined card base number selection rules;
(ii) whether or not said transaction card verification code matches an expected card verification code, derived, at least in part, from the associated verification base code of said fourth card base number entry.

9. The credit card set of claim 1,
wherein, when conducting a fourth payment transaction, for a specific payment amount, using said first type of purchasing procedure, in which said payment requester presents:
(i) said first account name;
(ii) a fourth transaction-specific card number;
(iii) said specific payment amount,
said card verification institution performs validation to determine whether or not said fourth transaction-specific card number matches an expected card number, derived, at least in part, from said specific payment amount and a fourth card base number entry, selected from said first ordered list, according to said first plurality of pre-determined card base number selection rules.

10. The credit card set of claim 1, further comprises a first plurality of verification base codes,
wherein, when conducting a fourth payment transaction, for a specific payment amount, using said first type of purchasing procedure, in which said payment requester presents:
(i) said first account name;
(ii) a fourth transaction-specific card number;
(iii) a transaction card verification code;
(iv) said specific payment amount,
said card verification institution performs validation to determine:
(i) whether or not said fourth transaction-specific card number matches an expected card number, derived, at least in part, from said specific payment amount and a fourth card base number entry, selected from said first ordered list, according to said first plurality of pre-determined card base number selection rules;
(ii) whether or not said transaction card verification code matches an expected card verification code, derived, at least in part, from said specific payment amount and a verification base code in said first plurality of verification base codes.

11. A credit card number maintenance device comprising:
(a) a processor unit;
(b) a memory unit, containing a card number base value descriptor;
(c) a card number output means;
(d) a card number request signaling means;
(e) a completion signaling means;
wherein, said processor unit uses said card number base value descriptor, at least in part, to generate a card number final value;
wherein, upon a card number request signal from said card number request signaling means, said processor unit sends said card number final value to said card number output means;
wherein upon a completion signal from said completion signaling means, said processor unit updates said card number base value descriptor, according to a predetermined updating procedure.

12. The credit card number maintenance device of claim 11,
wherein said card number base value descriptor comprises:
(i) a card number base table, containing an ordered list of three or more card number base entries;
(ii) a table index, pointing to a current card number base entry in said card number base table;
wherein said pre-determined updating procedure updates said table index to point to a next card number base entry.

13. The credit card number maintenance device of claim 11,
wherein said card number base value descriptor is a current card number base value;
wherein said pre-determined updating procedure updates said current card number base value, at least in part, using a random number generating algorithm.

14. The credit card number maintenance device of claim 11, further comprises a payment amount input means wherein said processor unit accepts a current payment amount from said payment amount input means and uses said current payment amount, in combination with said card number base value descriptor, to generate said card number final value.

15. The credit card number maintenance device of claim 11, further comprises a real-time clock means, wherein said processor unit stores the value of said real-time clock in said memory unit upon said completion signal.

16. A credit card set comprising:
(a) a credit card identification means, containing a first account name;
(b) a card number selection means, containing a first list of three or more card number entries, at least three of which are different in value;
wherein a card verification institution requires that a payment requester, when conducting a first payment transaction verification using a first type of purchasing procedure, to present:
(i) said first account name;
(ii) a first transaction-specific card number, derived, at least in part, from a first card base number entry, selected from said first list;
wherein said card verification institution requires that said payment requester, when conducting a second payment transaction verification using said first type of purchasing procedure, to present:
(i) said first account name;
(ii) a second transaction-specific card number, derived, at least in part, from a second card base number entry, selected from said first list, said second card base number entry is different from said first card base number entry in value;
wherein said card verification institution requires that said payment requester, when conducting a third payment transaction verification using said first type of purchasing procedure, to present:
(i) said first account name;
(ii) a third transaction-specific card number, derived, at least in part, from a third card base number entry, selected from said first list, said third card base number is different from said first card base number entry and said second card base number entry in value.

17. The credit card set of claim 16, wherein said first list is printed on paper, stored in an electronic device, or generated in an electronic device.

18. The credit card set of claim 16, further comprises a first plurality of verification base codes,
wherein each card base number entry in said first list is assigned an associated verification base code from said first plurality of verification base codes;
wherein, when conducting a fourth payment transaction, using said first type of purchasing procedure, in which said payment requester presents:
(iv) said first account name;
(v) a fourth transaction-specific card number;
(vi) a transaction card verification code,
said card verification institution performs validation to determine:
(iii) whether or not said fourth transaction-specific card number matches an expected card number, derived, at least in part, from a fourth card base number entry, selected from said first list;
(iv) whether or not said transaction card verification code matches an expected card verification code, derived, at least in part, from the associated verification base code of said fourth card base number entry.

19. The credit card set of claim 16,
wherein, when conducting a fourth payment transaction, for a specific payment amount, using said first type of purchasing procedure, in which said payment requester presents:
(i) said first account name;
(ii) a fourth transaction-specific card number;
(iii) said specific payment amount,
said card verification institution performs validation to determine whether or not said fourth transaction-specific card number matches an expected card number, derived, at least in part, from said specific payment amount and a fourth card base number entry, selected from said first list.

20. The credit card set of claim 16, further comprises a first plurality of verification base codes,
wherein, when conducting a fourth payment transaction, for a specific payment amount, using said first type of purchasing procedure, in which said payment requester presents:
(i) said first account name;
(ii) a fourth transaction-specific card number;
(iii) a transaction card verification code;
(iv) said specific payment amount,
said card verification institution performs validation to determine:
(i) whether or not said fourth transaction-specific card number matches an expected card number, derived, at least in part, from said specific payment amount and a fourth card base number entry, selected from said first list;
(ii) whether or not said transaction card verification code matches an expected card verification code, derived, at least in part, from said specific payment amount and a verification base code in said first plurality of verification base codes.
